(19) United States
(12) Patent Application Publication
(10) Pub. No.: US 2020/0074420 A1
(43) Pub. Date: Mar. 5, 2020

(54) PROVIDING DEVICE, PROCESSING SYSTEM, AND COMMUNICATION METHOD

(71) Applicant: SEIKO EPSON CORPORATION, Tokyo (JP)

(72) Inventors: Hitoshi YAMAKADO, Tokyo (JP); Tsuyoshi KAMEDA, Tokyo (JP); Hiroyuki KURAMOTO, Shiojiri (JP)

(21) Appl. No.: 16/550,350

(22) Filed: Aug. 26, 2019

(30) Foreign Application Priority Data
Aug. 28, 2018 (JP) 2018-158988

(51) Int. Cl. G06Q 20/06; H04L 9/32; G06Q 20/40

(52) U.S. Cl. CPC G06Q 20/065; H04L 9/3236; H04L 2209/56; H04L 2209/38; G06Q 20/401

(57) ABSTRACT

A providing device includes: a communication unit communicating with a network using a blockchain; and a processing unit controlling the communication unit. The processing unit generates a transaction for registering, into the blockchain, a processing program for controlling an electronic apparatus that is a management target, and issues the generated transaction to the network via the communication unit.

The present application is based on, and claims priority from JP Application Serial Number 2018-158988, filed Aug. 28, 2018, the disclosure of which is hereby incorporated by reference herein in its entirety.

### BACKGROUND

### 1. Technical Field

The present disclosure relates to a providing device, a processing system, and a communication method or the like.

### 2. Related Art

According to the related art, a management tool for collecting information of an electronic apparatus such as a printer and controlling a setting or the like of the electronic apparatus is known. For example, JP-A-2017-211901 discloses a management device which applies setting information generated based on capability information of a first device, to another device of the same model as the first device, and thus efficiently performs operation setting of a plurality of devices.

Various system configurations for executing a processing command to an electronic apparatus are conceivable. For example, a technique using a client/server system including a server on the sending side of a processing command and a client device receiving and executing the processing command is conceivable. The client device may be an electronic apparatus or a management device coupled to an electronic apparatus.

However, according to the related art, a technique using a blockchain technology in a system which performs processing to an electronic apparatus is not disclosed.

### SUMMARY

An aspect of the present disclosure relates to a providing device including: a communication unit communicating with a network using a blockchain; and a processing unit controlling the communication unit. The processing unit generates a transaction for registering, into the blockchain, a processing program for controlling an electronic apparatus that is a management target, and issues the generated transaction to the network via the communication unit.

### BRIEF DESCRIPTION OF THE DRAWINGS

FIG. 1 shows a configuration example of a providing device.

FIG. 2 shows a configuration example of a processing system.

FIG. 3 is an explanatory view of the related-art technique.

FIG. 4 is an explanatory view of a blockchain.

FIG. 5 is a flowchart explaining write processing to a blockchain.

FIG. 6 shows an example of a processing command and a processing program.

FIG. 7 shows an example of a blockchain in an embodiment.

FIG. 8 is a flowchart explaining processing in a processing device.

FIG. 9 is an explanatory view of a management application in the related-art technique.

FIG. 10 is an explanatory view of a management application in the embodiment.

FIG. 11 shows another example of the blockchain in the embodiment.

FIG. 12 shows another configuration example of the processing system.

### DESCRIPTION OF EXEMPLARY EMBODIMENTS

Hereinafter, an embodiment will be described. The embodiment described below should not unduly limit the content described in the appended claims. Not all the components described in the embodiment are necessarily essential components.

### 1. Outline

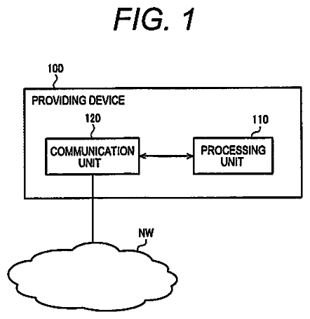

FIG. 1 shows a configuration example of a providing device 100 in this embodiment. The providing device 100 includes a communication unit 120 communicating with a network using a blockchain, and a processing unit 110 controlling the communication unit 120. The processing unit 110 generates a transaction for registering, into the blockchain, a processing program for controlling an electronic apparatus that is a management target. The processing unit 110 also issues the generated transaction to the network via the communication unit 120. The processing program, in a narrow sense, is a program for executing a processing command. The network using the blockchain is hereinafter referred to as a blockchain network NW. The phrase “register into the blockchain” specifically means that data is written into a block in the blockchain.

In the blockchain network NW, a data structure called a blockchain in which a plurality of blocks is linked together in the form of a chain is used. A transaction is a command issued when performing processing to register data into the blockchain. Each node in the blockchain network NW holds a blockchain of the same content. Therefore, when a transaction including a processing program issued by the providing device 100 is written into the blockchain, the processing program can be referred to from all the nodes participating in the blockchain network NW. This facilitates the provision of a processing program by the providing device 100. Also, each terminal executing the processing program can support an unknown processing command.

An electronic apparatus 300 is, for example, a printer. Alternatively, the electronic apparatus 300 may be a scanner, facsimile machine or copy machine. The electronic apparatus 300 may also be a multifunction peripheral (MFP) having a plurality of functions. An MFP having a print function is an example of the printer. The electronic apparatus 300 may also be a projector, head-mounted display device, wearable device, biological information measuring device such as pulse meter or activity meter, robot, video device such as camera, portable information terminal such as smartphone, or physical quantity measuring device or the like.

For example, when the electronic apparatus 300 is a printer, previously the number of sheets printed is collected for each of the sheet sizes of A4 and below, but it is conceivable that newly purchasing a printer enables printing on A3 sheets. In this case, a management application of a processing device 200 does not support the collection of the number of sheets printed of the new sheet size. For example, in the existing processing program, processing to read data in a data area where the number of sheets printed of each of the sheet sizes of A4 and below is stored is described, but processing to read a data area where the number of sheets printed of A3 sheets is stored is not described. The technique in this embodiment distributes a processing program in which a collection algorithm for an unknown sheet size is described, and thus enables continuation of the collection of proper information without updating the management application.

The processing unit 110 in the embodiment is formed of the following hardware. The hardware can include at least one of a circuit processing a digital signal and a circuit processing an analog signal. For example, the hardware can be formed of one or a plurality of circuit devices or one or a plurality of circuit elements, installed at a circuit board. The one or plurality of circuit devices is, for example, IC(s). The one or plurality of circuit elements is, for example, resistor(s), capacitor(s) or the like.

The processing unit 110 may also be implemented by the following processor. The providing device 100 in the embodiment includes a memory storing information, and a processor operating based on the information stored in the memory. The information is, for example, a program and various data or the like. The processor includes hardware. As the processor, various processors can be used, such as CPU (central processing unit), GPU (graphics processing unit), or DSP (digital signal processor. The memory may be a semiconductor memory such as SRAM (static random-access memory) or DRAM (dynamic random-access memory), register, magnetic storage device such as hard disk device, or optical storage device such as optical disk device. For example, the memory stores a computer-readable command. As the processor executes the command, the function of each part of the providing device 100 is implemented as processing. The command in this case may be a command in a command set forming a program, or a command instructing the hardware circuit of the processor to perform an operation.

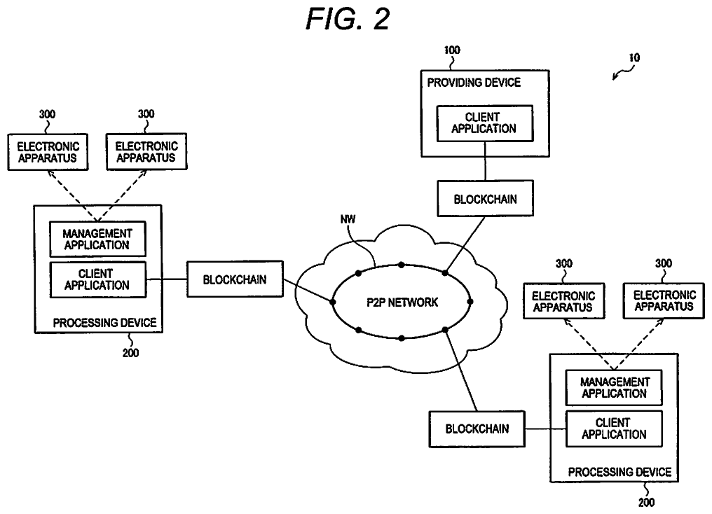

FIG. 2 shows a configuration example of a processing system 10 including the providing device 100 in the embodiment, and the processing device 200. The processing device 200 is a device which is provided corresponding to the electronic apparatus 300 and which executes a processing program. FIG. 2 shows an example where two processing devices 200 are provided and where two electronic apparatuses 300 are coupled to each processing device 200. However, the number of processing devices 200 and the number of electronic apparatuses 300 are not limited to this example. Also, while FIG. 2 shows an example where the processing device 200 and the electronic apparatus 300 are different apparatuses, the electronic apparatus 300 may include the processing device 200. That is, the electronic apparatus 300 may directly participate in the blockchain network NW and may receive a processing command and execute a corresponding processing program.

In the providing device 100 and the processing device 200, a client application of a blockchain is installed. The client application is software for participating in the blockchain network NW. The client application is software for executing various kinds of processing performed in the blockchain network NW, such as generation and issue of a transaction, processing of a consensus algorithm, and management of a cryptocurrency.

Also, a management application for managing the electronic apparatus 300 is installed in the processing device 200. The client application and the management application may be different applications that can cooperate with each other, or may be implemented as one application including both the blockchain client function and the management function for the electronic apparatus 300.

The management application performs collection of information from the electronic apparatus 300 and execution of a processing command to the electronic apparatus 300. For example, the management application carries out polling and acquires information of the electronic apparatuses 300 coupled to the same network. The communication between the management application and each electronic apparatus 300 is executed, for example, in conformity with SNMP (Simple Network Management Protocol). In this case, the processing device 200 including the management application is a communication manager, and each electronic apparatus 300 is a communication agent. The processing device executes a collection program and thus carries out communication conforming to SNMP and receives MIB (Management Information Base) information from the electronic apparatus. Various information acquisition intervals can be set. For example, approximately once to several times a day may be employed. The management application includes a processing program for controlling the electronic apparatus 300. When acquiring a processing command, the management application executes a processing program corresponding to the processing command and thus controls the electronic apparatus 300.

The technique in the embodiment may be applied not only to the providing device 100 shown in FIG. 1 but also to the processing system 10 shown in FIG. 2. As shown in FIG. 2, the processing system 10 according to the embodiment includes the providing device 100, and the processing device 200 which is provided corresponding to the electronic apparatus 300 and which acquires a processing program from the blockchain and executes the processing program.

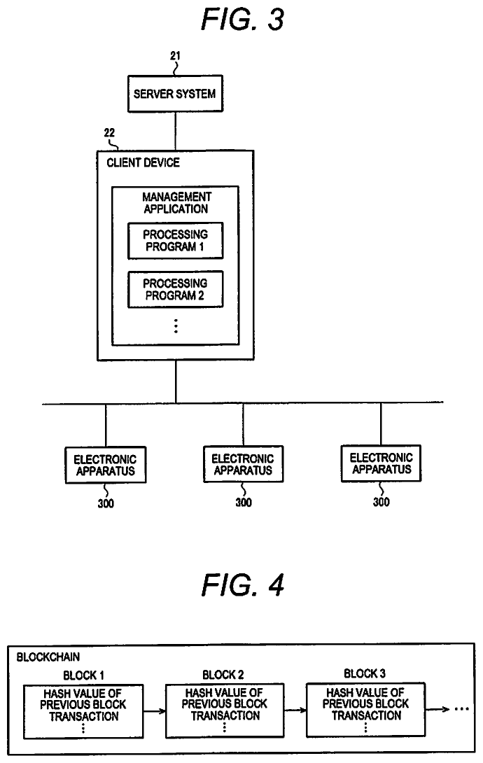

FIG. 3 explains the related-art technique for controlling the behavior and setting of the electronic apparatus 300. The system shown in FIG. 3 includes a server system 21 and a client device 22. The client device 22 is a management device managing the electronic apparatus 300. In the client device 22, a management application for managing the electronic apparatus 300 is installed. For example, a storage unit of the client device 22 stores the management application, and a processing unit of the client device operates according to the management application.

In executing a processing command to the electronic apparatus 300, the server system 21 transmits the processing command to the client device 22. The client device 22 has a processing program prepared in advance and executes a processing program corresponding to the received processing command, thus executing the processing command to the electronic apparatus 300.

In the technique shown in FIG. 3, the client device 22 can only support a known processing command and cannot support a new processing command. Specifically, the client device 22 can execute a processing command for which a corresponding processing program exists, but cannot execute a processing command for which a processing program does not exist. To support a new processing command, the management application of the client device 22 needs version upgrade. Although the server system 21 can prompt each client device 22 to carry out version upgrade, it is difficult to carry out version upgrade forcedly. Therefore, a processing command sent from the server system 21 to the client device 22 may not be properly executed by the client device 22. Compared with FIG. 3, the technique in the embodiment shown in FIGS. 1 and 2 is advantageous in that it can support an unknown processing command without version upgrade.

### 2. Blockchain and Smart Contract

The blockchain technology will now be described. The following description is a part of elements forming the blockchain technology. A different technical element may be added. Also, a part of the technical elements described below may be omitted. The blockchain technology in the embodiment also includes an extended form of each technical element.

Blockchain is a technique for distributed consensus building by participants in an open network. A blockchain network is a P2P network. Therefore, unlike a client/server system, no particular apparatus performs centralized management of data. In the blockchain network NW, data is managed based on a data structure called blockchain, where blocks are coupled together, and each node holds a common blockchain.

FIG. 4 explains the structure of a blockchain. One block includes data of a plurality of transactions, and data of the hash value of a previous block. The hash value of a previous block is specifically the hash value of the block header of the immediately previous block. Based on the hash value, a link between blocks is achieved. A transaction is a command issued by a node when registering data into the blockchain. For example, when doing business using a cryptocurrency, a transaction including information of the user address of the remitter, the user address of the remittee, and the amount of the remittance, or the like, is generated.

The generated transaction is broadcast with a signature of the sender and is propagated to each node in the blockchain network NW. The transmission of a transaction can be implemented by various data propagation algorithms used in the P2P network. For example, a method of simply transmitting a transaction to a neighboring node and repeating propagation from the neighboring node to another node may be employed. Alternatively, a particular node that is highly probable to exist, called a supernode, may be prescribed, and a transaction may be transmitted to the supernode. Defining the supernode as the destination can increase the probability that the transaction propagates to each node in the blockchain network NW.

Addition of a block to the blockchain is executed by a node called a miner. When a predetermined amount of transaction is accumulated, the miner attempts to generate a block including the transaction. The block is added to the blockchain under the condition that a consensus is built based on a consensus algorithm.

When PoW (Proof of Work) is used as the consensus algorithm, the hash value of the block header needs to satisfy a particular condition. The particular condition is, for example, the hash value is lower than a predetermined threshold. The block header includes a field called a nonce. The nonce is set by the miner. In other words, the miner executes processing to search for a nonce such that the hash value of the block header satisfies the particular condition. With a hash function for finding the hash value, it is difficult to predict an output value from an input value. Therefore, the miner needs to search for a nonce that satisfies the condition, by changing the nonce like a round-robin event. That is, PoW is a method of building a consensus based on the amount of work.

When a new block is generated by the miner, the block is verified at each node and then propagates in the blockchain network NW. The verification at each node is the processing to find a hash value and determine whether the hash value satisfies the particular condition or not. This processing can be executed within a short time.

The consensus algorithm is not limited to PoW. Other consensus algorithms may be used, such as PoS (Proof of Stake), which gives the right to speak according to the amount of cryptocurrency held, or PoI (Proof of Importance), which gives the right to speak according to the degree of importance of the participant. Also, when a specific signature is given, it may be unconditionally regarded that a consensus is built. When a private network which only a limited user and terminal can access is used, it may be unconditionally regarded that a consensus is built, without even the determination about signature. The consensus building based on the consensus algorithm in the embodiment includes the case where it is unconditionally regarded that a consensus is built.

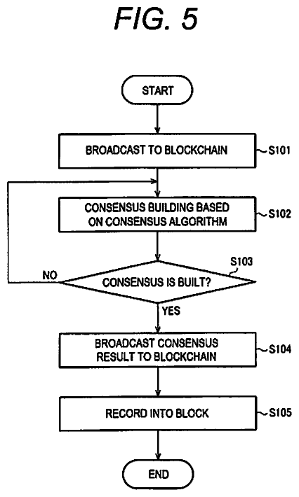

FIG. 5 is a flowchart explaining processing to write data into the blockchain. As this processing starts, first, a node that wishes to write data into the blockchain generates a transaction including the data and broadcasts the transaction in the blockchain network NW (S101). The notification to each node is not limited to broadcasting and may use other measures used in the P2P network, as described above.

Next, each node receiving the data carries out consensus building based on a consensus algorithm in order to determine whether the data can be written into the blockchain or not (S102). As the consensus algorithm, various algorithms such as PoW, PoS, and PoI can be employed, as described above. The processing of step S102 is repeated until a consensus is built based on the consensus algorithm (when No in step S103).

When a consensus is built based on the consensus algorithm (Yes in step S103), the consensus building is broadcast to each node (S104) and each node writes the data into the blockchain held by the node itself (S105). By this processing, the data broadcast in step S101 is added to the blockchain and becomes available to each node.

In the blockchain network NW, a program executed at a node can be added to the blockchain. The program includes a state and a function and is executed based on the execution environment within the node. The state may be rephrased as a set of variables. The function may be rephrased as subroutine, method or the like. The execution environment in the node is, for example, a virtual machine. Such a mechanism of adding a program to the blockchain and executing the program at a node is called a smart contract.

The writing of a program into the blockchain based on a smart contract is similarly executed according to the flow described with reference to FIG. 5. That is, a node that wishes to write based on a smart contract generates and broadcasts a transaction including the smart contract. When a consensus is built on the transaction based on the consensus algorithm, the program is written into the blockchain, based on the smart contract.

The processing unit 110 of the providing device 100 according to the embodiment generates a transaction for registering a processing program as a smart contract into the blockchain. Writing a processing program into the blockchain using a smart contract in this way enables execution of the processing program at an arbitrary node in the blockchain network NW.

### 3. Details of Processing

### 3.1 Processing Command and Processing Program

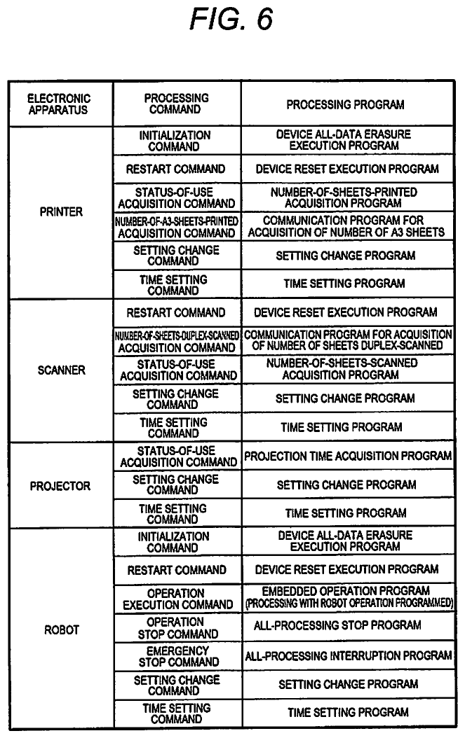

FIG. 6 explains a specific example of a processing command for controlling the electronic apparatus 300 and a processing program corresponding to the processing command. In FIG. 6, a printer, a scanner, a projector, and a robot are described as an example of the electronic apparatus 300.

For example, when the electronic apparatus 300 is a printer, the processing command for controlling the electronic apparatus 300 can be an initialization command, a restart command, a status-of-use acquisition command, a number-of-A3-sheets-printed acquisition command, a setting change command, or a time setting command.

The initialization command is a command to initialize the electronic apparatus 300, and for example, a command to return the electronic apparatus 300 into the state before shipment. The initialization command is executed by the processing device 200 performing processing according to a device all-data erasure execution program. The device all-data erasure execution program is a program in which processing procedures for erasing all the erasing target data of the electronic apparatus 300 are described.

The restart command is a command for turning on the power of the electronic apparatus 300 again after the power is temporarily turned off. The restart command is executed based on a device reset execution program in which procedures for turning on/off the power are described.

The status-of-use acquisition command is, for example, a command for acquiring the number of sheets printed, and is implemented by a number-of-sheets-printed acquisition program. The status-of-use acquisition command may also be a command for acquiring other information such as the amount of ink consumed or the amount of remaining ink, the operation time, or the amount of rotation of the motor.

The number-of-A3-sheets-printed acquisition command is a command for acquiring the number of A3 sheets printed and is implemented by a communication program for acquisition of the number of A3 sheets. That is, a processing command and a processing program for acquiring separate information may be used, apart from the status-of-use acquisition command.

The setting change command is a command for changing the setting of the printer. The setting of the printer is expressed by setting information, which is a combination of a setting item and a set value. The setting item is, for example, a setting item about security, a setting item about wireless LAN, a setting item about the supply source of print sheets, a setting item about the right of use of the device, a setting item about a predetermined communication protocol for connecting to a directory service on the network, or the like. The set value is information expressing the current setting state of each setting item. A setting change program is a program that is executed, for example, using the setting item and the set value as parameters, and that changes the set value of the setting item as a parameter to a value designated by a parameter.

The time setting command is a command for setting time and is implemented by a time setting program. That is, a processing command and a processing program for changing the set value of a separate setting item may be prescribed, apart from the setting change command.

As described above, the processing program includes a program for setting the electronic apparatus 300. This enables the processing device 200 to set the electronic apparatus 300. More specifically, as the providing device 100 provides a processing program for setting via the blockchain network NW, the processing device 200 can execute an unknown setting command, that is, a setting command to which the management application installed in the processing device 200 does not correspond. For example, even when a new electronic apparatus 300 is coupled to the processing device 200, the processing device 200 can execute the setting of the new electronic apparatus 300 without version upgrade of the management application.

Detailed description about the scanner, the projector, and the robot is omitted. However, for each electronic apparatus 300, a processing command corresponding to the type of the electronic apparatus 300 and a processing program corresponding to the processing command are set, as shown in FIG. 6. Thus, proper control according to the type of the electronic apparatus 300 can be achieved.

### 3.2 Processing Sequence

A specific processing flow in the embodiment will now be described. First, the providing device 100 specifies a processing command to be executed by a predetermined electronic apparatus 300 and a processing program for executing the processing command. The processing unit 110 of the providing device 100 then generates a transaction for registering a processing command for controlling the electronic apparatus 300 in association with a processing program, in a block in the blockchain. The generated transaction is broadcast in the blockchain network NW. This enables provision of not only a processing command but also a processing program corresponding to the processing command. Thus, as described later with reference to steps S203 to S205, the electronic apparatus 300 can be properly controlled regardless of the status of support of the processing command by the processing device 200.

The flow subsequent to the generation of the transaction is as described above with reference to FIG. 5. Specifically, processing using a consensus algorithm is carried out, and when consensus building is achieved, a block in which the transaction is placed is added to the blockchain.

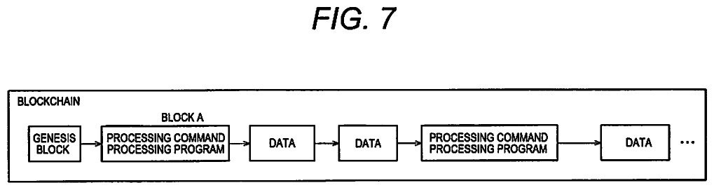

FIG. 7 shows an example of the blockchain in this case. In a block A, a transaction including a processing command and a processing program is placed. Adding the block A to the blockchain enables each node to acquire the processing command and execute the processing program using the execution environment within the node. The data in FIG. 7 includes arbitrary data communicated in the blockchain network NW. The data in FIG. 7 is not limited to the processing command and the processing program and may be, for example, log data representing the result of execution of the processing command, information representing cryptocurrency trading, or other information.

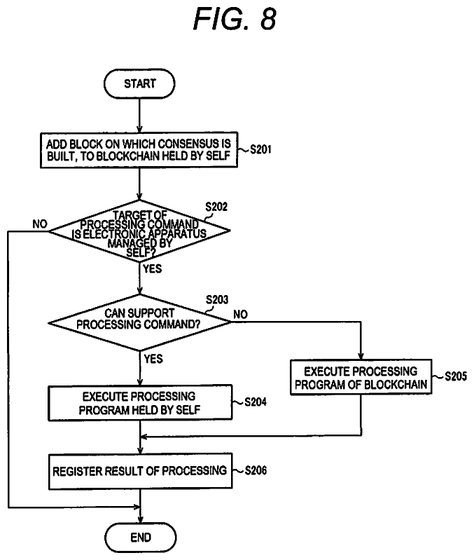

FIG. 8 is a flowchart explaining the processing executed by the processing device 200. The processing device 200 performs processing to add a block on which a consensus is built, to the blockchain held by the processing device 200 itself (S201). As shown in FIG. 5, the block on which a consensus is built is broadcast. Therefore, each node including the processing device 200 executes the processing of step S201, triggered by the reception of the block.

Next, the processing device 200 determines whether data included in the newly added block is data related to the processing device 200 itself or not. Specifically, the processing device 200 determines whether the block includes a processing command and the electronic apparatus 300 as the target of the processing command is a management target apparatus of the processing device 200 itself or not (S202). When No in step S202, the processing device 200 ends the processing about the processing command.

When Yes in step S202, the processing device 200 determines whether the processing device 200 itself can support the received processing command or not (S203). Step S203 is, for example, processing to determine version information. It is assumed, for example, that the processing command extends while maintaining downward compatibility, such as from ver.1.0 to ver.2.0 to ver.3.0. When the command version supported by the processing device 200 is ver.3.0, the processing device 200 can support a processing command of any of ver.1.0 to ver.3.0. Meanwhile, when the command version supported by the processing device 200 is ver.2.0, the processing device 200 can support a processing command of ver.1.0 or ver.2.0 but cannot process a processing command of ver.3.0. When the command version supported by the processing device 200 is ver.1.0, the processing device 200 can support a processing command of ver.1.0 but cannot process a processing command of ver.2.0 or ver.3.0.

Alternatively, the determination in step S203 may be carried out, based on capability information of the processing device 200. For example, the case where the processing command is a setting change command for network setting is considered. As types of network setting, “IP (Internet Protocol) setting”, “wireless LAN (Local Area Network) setting”, and “login information setting” are conceivable. The capability information of the processing device 200 is information specifying a setting type executable by the processing device 200. For example, the capability information of the processing device 200 is information representing that the processing device 200 can execute “IP setting” and “login information setting”. In this circumstance, when the processing command defines the three types of “IP setting”, “wireless LAN setting”, and “login information setting”, the processing device 200 cannot support “wireless LAN setting”.

Alternatively, the processing of step S203 may be implemented, based on a combination of version number and capability information. For example, when “wireless LAN setting ver.1.0” and “wireless LAN setting ver.2.0” exist and where the processing command includes “wireless LAN setting ver.2.0”, the processing device 200 determines that it can support the processing command, when the capability information includes “wireless LAN setting” and the corresponding command version about this “wireless LAN setting” is ver.2.0 or above.

When Yes in step S203, the processing device 200 can execute the processing command without newly acquiring a processing program. Therefore, the processing device 200 executes the processing program held by the processing device 200 and thus executes the processing command to the electronic apparatus 300 (S204).

When No in step S203, a processing program is needed for the processing device 200 to execute the processing command. In the foregoing example, for example, a processing program that can process up to ver.3.0 or a processing program for executing “wireless LAN setting”, or the like, is needed. As shown in the block A in FIG. 7, not only a processing command but also a processing program corresponding to the processing command are added to the blockchain in the embodiment. Therefore, the processing device 200 executes the processing program stored in the blockchain, in the execution environment (S205). By the processing of step S204 or S205, the control of the electronic apparatus 300 based on the processing command is executed.

As described above, the processing device 200 receives a processing command for controlling the electronic apparatus 300 from the providing device and determines whether the processing device 200 itself supports the received command or not. When the processing device 200 determines that the processing device 200 itself does not support the processing command, the processing device 200 acquires a processing program corresponding to the processing command from the blockchain. Thus, the processing device 200 can support an unknown processing command without version upgrade of the management application of the processing device 200.

The processing device 200 may perform processing to generate a transaction for registering the result of execution of the processing command, in a block in the blockchain. The result of execution of the processing command is specifically the result of execution of the processing program corresponding to the processing command. For example, as shown in FIG. 8, the processing device 200 performs processing to register the result of processing in the blockchain (S206) after executing the processing program shown in step S204 or S205. Specifically, the processing device 200 generates a transaction including the result of processing and broadcasts the transaction in the blockchain network NW. Subsequently, when a consensus is built based on a consensus algorithm, a block including the result of processing is added to the blockchain. Thus, another node in the blockchain network NW can acquire the result of execution of the processing command. More specifically, the providing device 100, which is the transmission source of the processing command, can acquire the result of execution.

The result of execution in this case is information representing success/failure of the processing command, when the processing command is an initialization command, restart command, or setting change command. For example, the providing device 100 can display the result of execution, thus informing the user of the result of the processing command. This can improve convenience.

Registering the result of processing in the blockchain is particularly important when the processing command is an information collection command. That is, the processing command is an information collection command, and the processing device 200 generates a transaction for registering management information of the electronic apparatus 300, which is the result of execution of the collection command, in the blockchain. In this case, the processing program corresponding to the processing command is a program for executing the collection command. Thus, another node, and in a narrow sense, the providing device 100, can acquire the information of the electronic apparatus 300.

The information collection command is, for example, the status-of-use acquisition command shown in FIG. 6. In this case, the management information is information representing the status of use of the electronic apparatus 300 and is information of the number of sheets printed or information of the number of sheets scanned, or the like. However, the management information is not limited to information representing the status of use. For example, the management information may be state information of the electronic apparatus 300. When the electronic apparatus 300 is a printer, the state represented by the state information includes various states such as “idle state”, “now printing”, and “error state”. The idle state is a state where printing is executable but no print job is entered. The error state is a state where a print job cannot be executed because an error is generated.

The management information registered in the blockchain by the processing device 200 can be used in various kinds of processing. For example, the processing unit 110 of the providing device 100 may perform alert processing or report information generation processing, based on the management information written in the blockchain. The information written in the blockchain can be referred to from a node other than the providing device 100. Therefore, depending on the configuration of the processing system 10, a device other than the providing device 100 may perform the alert processing or the report information generation processing. However, when the providing device 100 is used to manage the electronic apparatuses 300 of a plurality of clients, it is not preferable that information about a certain client is leaked to another client. In this case, the processing device 200 performs processing to encrypt the management information into a form that can be decrypted only by the providing device 100 and register the encrypted management information into the blockchain. This can limit the agent executing the management information reference processing, the alert processing, and the report information generation processing, to the providing device 100.

The alert processing is processing to alert the user of the electronic apparatus 300. For example, the providing device 100 performs the alert processing when the electronic apparatus 300 turns into the error state. Alternatively, the providing device 100 sets a normal range in advance with respect to the number of sheets printed and the operating time during a predetermined period, and performs the alert processing when the acquired number of sheets printed or the like exceeds the normal range. Thus, the user can be alerted when the electronic apparatus 300 is used in an inappropriate manner. The alert processing may be implemented by processing to register alert information into the blockchain. However, since an alert needs immediacy to a certain extent, the alert processing may be implemented by processing without involving the blockchain, such as processing to transmit an email to the terminal used by the user.

The report information generation processing is processing to generate a report based on the management information. For example, the providing device 100 generates a report summarizing operation information of the electronic apparatus 300 during a predetermined period. The management information of the electronic apparatus 300 includes various kinds of information such as information of consumable parts, information about operating time, and detection value of a sensor provided inside. Also, there may be a case where one user uses multiple electronic apparatuses 300. In this case, when the management information is presented as it is, it may be difficult for the user to understand the information because of the large amount of the information. In this respect, summarizing the management information as a report can facilitate the user's understanding. The report includes, for example, the result of statistical processing of numerical data such as the amount of consumption, and a visual expression of various kinds of information using a graph or the like.

Alternatively, the processing unit 110 of the providing device 100 may perform charging processing corresponding to the status of use of the electronic apparatus 300, based on the management information written in the blockchain. For example, a charging service provider enters into a contract for charging with each user in advance. When the electronic apparatus 300 is a printer, for example, a contract to the effect that the user will be “charged according to the number of sheets printed, at a rate of x yen per sheet” or the like, is made. In this case, the providing device 100 performs processing to acquire information of the number of sheets printed per unit period as the management information and decide the amount charged, based on the number of sheets printed and the content of the contract. A request for payment of the decided amount charged is carried out, for example, by email or by mail. Thus, the management information can be collected regardless of the status of support of the processing command by the processing device 200, and the charging processing to the user can be smoothly carried out.

### 4. Modification Examples

Some modification examples will now be described.

### 4.1 Change of Consensus Algorithm

In a blockchain, after a transaction is broadcast, consensus building based on a consensus algorithm is needed before the transaction is actually placed in a block. The time required from issuing a transaction to writing the transaction into the blockchain depends on the difficulty of consensus building. The difficulty is decided according to the consensus algorithm.

As described above, in the processing system 10 according to the embodiment, various kinds of information is written into the blockchain. The required immediacy varies depending on the type of the information. For example, writing a processing command and a processing program may take time to a certain extent without posing a serious problem. This is because it is important for a processing command to be securely executed, and therefore in most cases, the time taken for the execution does not pose a problem unless it is excessively long.

In contrast, it is desirable that the result of processing is written within a relatively short time. When writing the result of processing into the blockchain takes time, the providing device 100 cannot recognize that a processing command is actually executed. In other words, there is a discrepancy between the providing device 100 and the processing device 200 in recognizing whether a processing command is executed or not. Therefore, the user of the providing device 100 may try to execute the same processing command again by mistake. Alternatively, when the state information of the electronic apparatus 300 is written, the state of the electronic apparatus 300 may shift during consensus building and the state information written in the blockchain may be different from the actual state of the electronic apparatus 300.

Thus, the providing device 100 and the processing device 200 may use different consensus algorithms between a transaction for registering a processing program into the blockchain and a transaction for registering the management information into the blockchain. In the foregoing example, for a second transaction for registering the management information into the blockchain, a consensus algorithm that makes consensus building easier than for a first transaction for registering a processing program into the blockchain is used. For example, for the first transaction, PoW or PoS is used as the consensus algorithm. In contrast, for the second transaction, it is unconditionally regarded that a consensus is built. Thus, the time taken for consensus building can be varied according to the type of the information. This enables execution of writing of information into the blockchain according to the immediacy required of the information.

The consensus algorithm is common to all the nodes in the blockchain network NW. Therefore, when a device other than the providing device 100 and the processing device 200 exists as a node, the consensus algorithm is switched according to the type of the information also at this node.

The “different consensus algorithms” in this example may refer to different difficulties of consensus building. Therefore, an embodiment where PoW is used as the consensus algorithm for both the first transaction and the second transaction may be employed. In this case, the condition to be satisfied by the hash value of the block header is different between the first transaction and the second transaction. For example, for the second transaction, an allowable hash value range is set to be broader than for the first transaction.

Although the case where the first transaction for registering a processing program into the blockchain does not need immediacy is described above as an example, this is not limiting. For example, when transmitting a processing command for emergency stop of the electronic apparatus 300, it is desirable that the processing command and the processing program are written into the blockchain within the shortest possible time. That is, to change the difficulty of consensus building in the consensus algorithm, determination may be made in terms of whether or not immediacy is required of the information that is the writing target, instead of whether it is a processing command and a processing program, or not.

### 4.2 Management of Electronic Apparatuses of Plurality of Types

As described above, the electronic apparatus 300 according to the embodiment may be various apparatuses such as printer, scanner, projector, and robot.

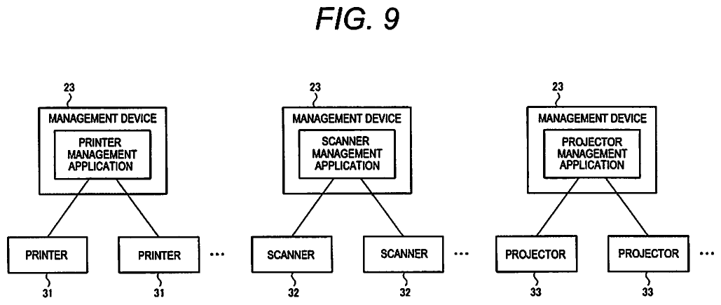

FIG. 9 explains the related-art technique when managing electronic apparatuses 300 of a plurality of types. According to the related art, management of a printer 31 is executed by a management application for printer. A scanner 32 and a projector 33, too, are similarly managed, using a dedicated management application. Also, other electronic apparatuses 300, such as robot, are similarly managed. For example, when one company uses electronic apparatuses 300 of a plurality of types, management devices 23 corresponding to the types of the apparatuses need to be provided, as shown in FIG. 9. Alternatively, one management device 23 may be used, but a plurality of management applications corresponding to the types of the electronic apparatuses 300 need to be installed in the management device 23.

This is because the processing command that is assumed varies depending on the type of the electronic apparatus 300, as described above with reference to FIG. 6. According to the related art, in order to manage these types and processing commands by one management application, processing programs assumed with respect to all the electronic apparatuses 300 must be held. Such a versatile management application needs to frequently upgrade the version of the processing programs.

In this respect, the technique according to the embodiment can distribute a proceeding program via a blockchain. For example, the processing device 200 in the embodiment may include a storage unit storing a processing program corresponding to a processing command common to electronic apparatuses 300 of a plurality of types. The processing device 200 acquires a processing program corresponding to a processing command corresponding to the type of an electronic apparatus 300, from the blockchain. This can implement a versatile management application that can manage of electronic apparatuses 300 of a plurality of types.

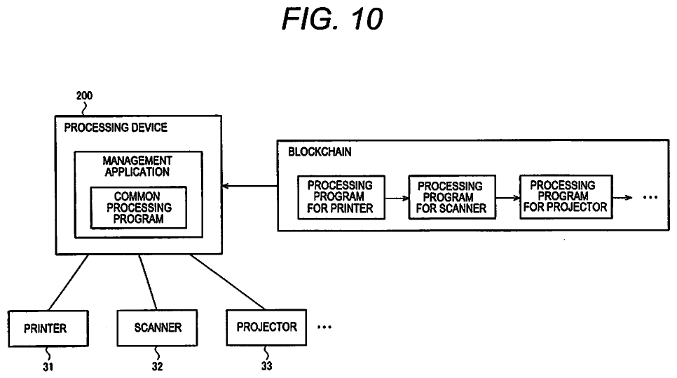

FIG. 10 explains the technique according to the embodiment. As shown in FIG. 10, one versatile management application is installed in the processing device 200. The management application includes a processing program common to a plurality of electronic apparatuses 300. Also, a processing programs specific to the types of the electronic apparatuses 300, such as a processing program for printer, a processing program for scanner, and a processing program for projector, are written in the blockchain. These processing programs are programs which a transaction is issued to register, as in the foregoing example.

4.3 Determination at Providing Device Side about Whether Processing Device Supports Processing Command or not

In the example described above with reference to FIG. 8, the processing device 200 determines whether the processing device 200 supports a processing command or not. In this case, the providing device 100 issues a transaction for registering the processing command in association with a processing program into the blockchain, without considering whether the processing device 200 supports the processing command or not.

However, the determination about whether the processing device 200 supports a processing command or not may be carried out by the providing device 100. The processing unit 110 of the providing device 100 determines whether the processing device 200 provided corresponding to the electronic apparatus 300 supports a processing command or not. When the processing device 200 does not support the processing command, the processing unit 110 generates a transaction for registering a processing program corresponding to the processing command, into the blockchain. Thus, whether to carry out the registration of the processing program or not can be decided, based on the status of support by the processing device 200. Specifically, when the processing device 200 supports the processing command, the providing device 100 transmits only the processing command and can omit the transmission of the processing program.

For example, the processing device 200 transmits version information of a processing command supported by the processing device 200 itself in advance, or capability information of the processing device 200 itself, or a combination of the version information and the capability information, to the providing device 100. The processing device 200 may issue a transaction for registering the version information and the capability information into the blockchain or may transmit the version information or the like to the providing device 100 via a different route from the blockchain. The providing device 100 determines whether the processing device 200 supports the processing command or not, based on at least one of the version information and the capability information, as in the example of step S203 in FIG. 8.

### 4.4 Modification Example of Correspondence Between Processing Command and Processing Program

In the above description, an example where the providing device 100 performs processing to simultaneously register a processing command and a processing program into the blockchain is described. For example, a transaction including both a processing command and a processing program is issued, thus establishing a correspondence between the processing command and the processing program.

However, it suffices that when the processing device 200 receives a processing command, the processing device 200 can specify a processing program corresponding to the processing command. The simultaneous registration of a processing command and a processing program is not limiting.

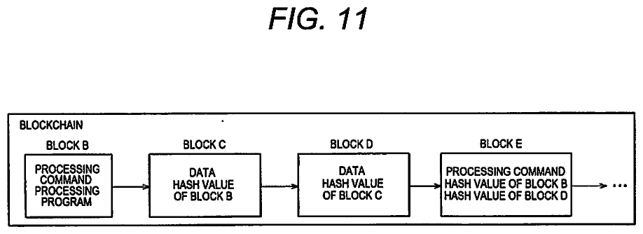

FIG. 11 explains the configuration of a blockchain. For example, when registering for the first time a processing program corresponding to a predetermined processing command, the providing device 100 performs processing to simultaneously register the processing command and the processing program into the blockchain. The block added by this processing is a block B. Blocks C and D are blocks including predetermined data. As described above with reference to FIG. 4, the block C includes the hash value of the block B, which is the previous block. The block D includes the hash value of the block C, which is the previous block. Although not illustrated in FIG. 11, when the block B is not the genesis block, the block B includes the hash value of the previous block. Now, a case where the processing command corresponding to the same processing program is registered again into the blockchain will be considered. In this case, the providing device 100 issues a transaction for registering information specifying the block B along with the processing command into the blockchain. The information specifying the block B is, for example, the hash value of the block header of the block B. The block added by this processing is a block E. The hash value of the block B included in the block E is information specifying the block including the processing program and is different from the hash value of the previous block. Specifically, the block E includes the hash value of the block D, which is the previous block.

In the blockchain, each node can refer to the first to latest blocks. Therefore, when a processing program is written in the block B, the processing device 200 can execute the processing program at an arbitrary timing. In the example of FIG. 11, as the block E is added, a predetermined processing device 200 attempts to execute the processing command of the block E. When the processing device 200 does not support the processing command, the processing device 200 can specify the processing program based on the hash value of the block B included in the block E and execute the processing program in the execution environment. Thus, the same processing program can be restrained from being written duplicatively into the blockchain.

Moreover, when a processing program is written for the first time, the processing program need not be written simultaneously with a processing command. For example, when a new processing program is created at the providing device 100, a transaction for registering the processing program into the blockchain is issued, regardless of the timing of execution of the processing command. The processing command corresponding to the processing program thus written is associated with reference information of the processing program, as in the block E in FIG. 11, in any of the first, second, and subsequent writings. As described above, the association between a processing program and a processing command in the embodiment can be implemented in various forms.

To support an unknown processing command without version upgrade, it suffices that the processing program can be distributed in the blockchain.

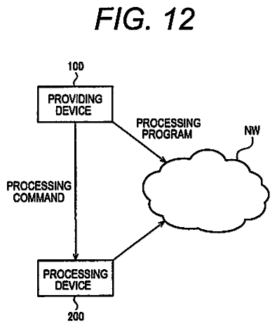

FIG. 12 explains an example of a communication route in the processing system 10 according to the embodiment. As shown in FIG. 12, the providing device 100 and the processing device 200 are respectively nodes in the blockchain network NW. The providing device 100 issues a transaction for registering a processing program into the blockchain. The processing program is written into the blockchain.

In the example of FIG. 12, the providing device 100 and the processing device 200 can communicate via a communication route without using the blockchain network NW. The providing device 100 transmits a processing command to the processing device 200, using this communication route. The processing device 200 determines whether the processing device 200 itself supports the received processing command or not. When not supporting the receiving processing command, the processing device 200 executes a processing program of the blockchain in the execution environment. For example, when transmitting a processing command, the providing device 100 also transmits information of the hash value of a block including a corresponding processing program. This configuration, too, can associate a processing command and a processing program. Thus, the processing device 200 can support an unknown processing command without version upgrade.

The providing device according to the embodiment includes: a communication unit communicating with a network using a blockchain; and a processing unit controlling the communication unit. The processing unit generates a transaction for registering, into the blockchain, a processing program for controlling an electronic apparatus that is a management target, and issues the generated transaction to the network via the communication unit.

In the embodiment, the processing to register a processing program for controlling the electronic apparatus, into the blockchain, is performed. Writing a processing program into the blockchain enables execution of the processing program at each node in the network using the blockchain. Thus, management of the electronic apparatus can be properly executed, using the blockchain.

In the embodiment, the processing program may be a program for performing a setting of the electronic apparatus.

Thus, the setting of the electronic apparatus can be properly executed, using the blockchain.

In the embodiment, the processing unit may generate the transaction for registering the processing program as a smart contract into the blockchain.

Thus, the processing program can be provided as a smart contract in the blockchain technology.

In the embodiment, the processing unit may generate the transaction for registering a processing command for controlling the electronic apparatus in association with the processing program, into the blockchain.

Thus, the processing command corresponding to the processing program can be provided using the blockchain.

In the embodiment, the processing unit may determine whether a processing device provided corresponding to the electronic apparatus supports the processing command or not, and may generate the transaction for registering the processing program corresponding to the processing command into the blockchain when it is determined that the processing device does not support the processing command.

Thus, the providing device can determine whether the processing device supports the processing command or not, and properly provide the processing program according to the result of the determination.

The processing system according to the embodiment includes: the providing device described in one of the above paragraphs; and a processing device that is provided corresponding to the electronic apparatus and that acquires a processing program from the blockchain and executes the processing program.

Thus, a system controlling the electronic apparatus by providing and executing the processing program using the blockchain can be implemented.

In the embodiment, the processing device may receive a processing command for controlling the electronic apparatus from the providing device, determine whether the processing device itself supports the received processing command, and acquire the processing program corresponding to the processing command from the blockchain when it is determined that the processing device does not support the processing command.

Thus, the processing device can determine whether the processing device supports the processing command or not, and can properly execute the processing program according to the result of the determination.

In the embodiment, the processing device may perform processing to generate the transaction for registering a result of execution of the processing program into the blockchain.

Thus, the result of execution of the processing program can be written into the blockchain. For example, at the node of the transmission source of a processing command, the result of execution of the processing program corresponding to the processing command can be confirmed.

In the embodiment, the processing device may include a storage unit storing the processing program common to the electronic apparatuses of a plurality of types. The processing device may acquire the processing program corresponding to the type of the electronic apparatus from the blockchain.

Thus, even when electronic apparatuses of a plurality of types are control targets, control of the electronic apparatuses can be efficiently executed.

In the embodiment, the processing program may be a program executing a collection command for information. The processing device may generate the transaction for registering management information of the electronic apparatus, which is a result of execution of the collection command, into the blockchain.

Thus, the management information acquired by executing the collection command for information can be written into the blockchain.

In the embodiment, the providing device and the processing device may use different consensus algorithms between the transaction for registering the processing program into the blockchain and the transaction for registering the management information into the blockchain.

Thus, the consensus algorithms can be flexibly changed according to the information that is a target of writing into the blockchain. For example, the time taken from issuing a transaction to writing into the blockchain can be adjusted.

In the embodiment, the processing unit of the providing device may perform alert processing or report information generation processing, based on the management information written in the blockchain.

Thus, the providing device can execute various kinds of processing based on the management information.

In the embodiment, the processing unit of the processing device may perform charging processing corresponding to a status of use of the electronic apparatus, based on the management information written in the blockchain.

Thus, the providing device can execute various kinds of processing based on the management information.

The communication method according to the embodiment is a communication method in a network using a blockchain. The method includes: generating a transaction for registering, into the blockchain, a processing program for executing a processing command to an electronic apparatus that is a management target; and issuing the generated transaction to the network.

The embodiment is described in detail above. However, a person skilled in the art can readily understand that various modifications can be made without substantially departing from the new matters and effects of the present disclosure. Therefore, all such modifications are included in the scope of the present disclosure. For example, a term described along with a different term having a broader meaning or the same meaning, at least once in the specification or drawings, can be replaced with the different term at any point in the specification or drawings. Also, all combinations of the embodiment and modifications are included in the scope of the present disclosure. The configuration and operation of the providing device, the processing device and the like are not limited to those described in the embodiment and can be implemented with various modifications.

What is claimed is:

1. A providing device comprising:
a communication circuit communicating with a network using a blockchain; and
a processor controlling the communication unit, wherein
the processor generates a transaction for registering, into the blockchain, a processing program for controlling an electronic apparatus that is a management target, and issues the generated transaction to the network via the communication circuit.

2. The providing device according to claim 1, wherein
the processing program is a program for performing a setting of the electronic apparatus.

3. The providing device according to claim 1, wherein
the processor generates the transaction for registering the processing program as a smart contract into the blockchain.

4. The providing device according to claim 1, wherein
the processor generates the transaction for registering a processing command for controlling the electronic apparatus in association with the processing program, into the blockchain.

5. The providing device according to claim 4, wherein
the processor
determines whether a processing device coupled to the electronic apparatus supports the processing command or not, and
generates the transaction for registering the processing program corresponding to the processing command into the blockchain when it is determined that the processing device does not support the processing command.

6. A processing system comprising:
a providing device comprising a communicator communicating with a network using a blockchain, and a processor controlling the communicator, wherein
the processor generates a transaction for registering, into the blockchain, a processing program for controlling an electronic apparatus that is a management target, and issues the generated transaction to the network via the communicator; and
a processing device coupled to the electronic apparatus and acquiring and executing the processing program registered in the blockchain.

7. The processing system according to claim 6, wherein
the processing device receives a processing command for controlling the electronic apparatus from the providing device, determines whether the processing device itself supports the received processing command, and acquires the processing program corresponding to the processing command from the blockchain when it is determined that the processing device does not support the processing command.

8. The processing system according to claim 6, wherein
the processing device performs processing to generate the transaction for registering a result of execution of the processing program into the blockchain.

9. The processing system according to claim 6, wherein
the processing device includes a storage storing the processing program common to the electronic apparatuses of a plurality of types, and
the processing device acquires the processing program corresponding to the type of the electronic apparatus from the blockchain.

10. The processing system according to claim 6, wherein
the processing program is a program executing a collection command for information, and
the processing device generates the transaction for registering management information of the electronic apparatus, which is a result of execution of the collection command, into the blockchain.

11. The processing system according to claim 10, wherein
the providing device and the processing device use different consensus algorithms between the transaction for registering the processing program into the blockchain and the transaction for registering the management information into the blockchain.

12. The processing system according to claim 10, wherein
the processor of the providing device performs alert processing or report information generation processing, based on the management information written in the blockchain.

13. The processing system according to claim 10, wherein
the processor of the providing device performs charging processing corresponding to a status of use of the electronic apparatus, based on the management information written in the blockchain.

14. A communication method in a network using a blockchain, the method comprising:
generating a transaction for registering, into the blockchain, a processing program for controlling an electronic apparatus that is a management target; and
issuing the generated transaction to the network.
